(19) United States
(12) Patent Application Publication
(10) Pub. No.: US 2013/0029303 A1
(43) Pub. Date: Jan. 31, 2013

(54) Teaching System

(71) Applicants: Eric E. Simanek, Fort Worth, TX (US); Zachary Mohammad Abid, Fort Worth, TX (US); Nicholas Bigham, Lubbock, TX (US); Kevin Scott Chatley, Plano, TX (US); Sandra Bichanh-Tran Dang, North Richland Hills, TX (US); Abigail Rose Moore, Huntley, IL (US); Katelyn Elizabath Poole, Austin, TX (US); Thomas Purgett, Colleyville, TX (US); Erika Sue Zimmerman, Fort Worth, TX (US)

(72) Inventors: Eric E. Simanek, Fort Worth, TX (US); Zachary Mohammad Abid, Fort Worth, TX (US); Nicholas Bigham, Lubbock, TX (US); Kevin Scott Chatley, Plano, TX (US); Sandra Bichanh-Tran Dang, North Richland Hills, TX (US); Abigail Rose Moore, Huntley, IL (US); Katelyn Elizabath Poole, Austin, TX (US); Thomas Purgett, Colleyville, TX (US); Erika Sue Zimmerman, Fort Worth, TX (US)

(21) Appl. No.: 13/556,594

(22) Filed: Jul. 24, 2012

Related U.S. Application Data
(60) Provisional application No. 61/511,278, filed on Jul. 25, 2011.

(51) Int. Cl. G09B 23/40

(52) U.S. Cl. 434/299

(57) ABSTRACT

A teaching system comprising a visual aid printed on at least one side of a sheet material, a modeling implement, and an access indicia for connecting a user to remote resource materials. The visual aid may include at least one illustrated side containing information about a scientific theory, describing origins, descriptions, mechanisms, and evidence of the scientific theory. The modeling implement may be a die cutting tool having a tessellated array of cells in a panel, wherein each cell shares a portion of its border with an adjacent cell, and a die cutting edge extending from one side of the panel. The combination may be used as an efficient and interesting teaching aid in a variety of settings.

The present Application claims priority to U.S. Provisional Patent Application Ser. No. 61/511,278 filed Jul. 25, 2011 and entitled: “GEOGRAPHICAL TEACHING AID.”

### BACKGROUND OF THE INVENTION

1. Field of the Invention

The present invention generally relates to teaching aids and more particularly to teaching aids that combine a visual aid and a hands-on implement used in a participatory learning environment.

2. Background of the Invention and Description of the Prior Art

Traditional instruction generally relies on instructor presentations such as lectures or discussions supplemented by textual material, usually in the form of text books or other written material. Occasionally visual aids such as films, videos, or field trips may be used to expand the material presented. In science units or courses, laboratory exercises or experiments are often included to provide direct experience with the concepts presented in the classroom or supplementary materials. Examples may include or involve models, specialized laboratory equipment, or project kits students may use to gain first-hand experience with the subject matter. Thus, supplementary materials may be available in many forms in an effort to present new material in ways that capture attention of and sustain the interest of students. In teaching geography and earth sciences, for example, learning materials traditionally rely on maps, visual images, and textual material to teach the principles of the subject.

In an example of presenting the principles of plate tectonics, one participatory technique is to have the students cut out paper outline figures of the continental plates, which may then be assembled together to represent the supercontinent Pangeia (or alternately, Pangea) as it existed during the Triassic age some 225 million years ago. The cut outs may then be moved to simulate continental drift caused over millions of years by geologic forces, leading to a better understanding of the processes involved.

However, a substantial disadvantage of this teaching method is that students usually require considerable amounts of time engaged in the manual task to cut out the outline figures. As a result, very little of the time allotted to teaching the subject is actually spent learning the subject matter because most of it is spent making the outline figures. Another disadvantage is that assembling the paper cut outs and retaining them in an assembled configuration is often difficult and likewise consumes valuable learning time.

What is needed is a more efficient way to involve the students in a hands-on activity such as tactile/kinetic learning exercises that contributes to the learning process without spending inordinate amounts of time on manual tasks that have little to do with learning the subject matter.

### SUMMARY OF THE INVENTION

Accordingly, the present invention provides a teaching system that combines a visual aid device, an efficient hands-on modeling implement, and access indicia links to remote resources to maximize the time allotted in a small number of class periods to be spent in learning tasks.

In one embodiment, a teaching system is provided comprising a visual aid printed on first and second sides of a sheet material describing educational subject matter; a compound die cutting tool having a plurality of separate die cutting cells formed in a panel, each cell representing one of a plurality of related components of the educational subject matter, for modeling a concept of the subject matter described on the visual aid; and at least one resource access indicia imprinted on the visual aid or the die cutting tool. In other aspects the visual aid may be formed as a place mat having information on a first side about origins and descriptions of a scientific theory, and a second side of the place mat having information about mechanisms and evidence of the scientific theory. In an alternate embodiment the place mat may have at least one illustrated side containing information about a scientific theory selected from the group consisting of origins, descriptions, mechanisms, and evidence of the scientific theory.

In another aspect, the die cutting tool comprises a tessellated array of cells, wherein each cell is formed as an opening in the panel to represent a defined element of an assembly of pictorial elements, and each cell shares a portion of its border with an adjacent cell along a common boundary that includes a die cutting edge formed there along and extending from one side of the panel.

In another aspect, the resource access indicia comprises access indicia selected from the group consisting of bar codes, quick response (QR) codes, uniform resource locators (URLs), email addresses, textual addresses, bibliographic statements, and footnotes. The QR codes or other access indicia imprinted on the visual aid may provide links to remote resources for further information about the subject matter of the teaching system.

In an alternate embodiment, the teaching system includes a visual aid formed as a place mat having at least one illustrated side containing information about a scientific theory selected from the group consisting of origins, descriptions, mechanisms, and evidence of the scientific theory; a compound die cutting tool having a tessellated array of die cutting cells formed in a panel, each cell representing one of a plurality of related components of the scientific theory and each cell boundary including a die cutting edge formed there along and extending from one side of the panel, for modeling in a moldable material a concept of the scientific theory described on the visual aid; and at least one resource access indicia imprinted on the visual aid or the die cutting tool providing links to remote resources for further information about the scientific theory. In other aspects, the die cutting tool further comprises a one piece panel formed of molded thermoplastic material having legends identifying each cell formed in a top side thereof and die cutting edges formed integral with the panel on an underside thereof; and the resource access indicia comprises access indicia selected from the group consisting of bar codes, quick response (QR) codes, uniform resource locators (URLs), email addresses, textual addresses, bibliographic statements, and footnotes.

In another alternate embodiment, a method for teaching a scientific theory is provided comprising the steps of providing a printed sheet having at least one illustrated side containing information about a scientific theory selected from the group consisting of origins, descriptions, mechanisms, and evidence of the scientific theory; providing an implement for modeling at least one principal concept of the scientific theory; and imprinting said printed sheet or implement with at least one resource access indicia to connect a student or teacher to remote resource materials about the scientific theory.

In another aspect of the method the step of providing an implement for modeling comprises the steps of providing a die cutting tool with a tessellated array of openings formed in a panel wherein each opening defines a cell in the panel, each cell defining an element of an assembly of pictorial elements; and wherein each cell shares a portion of its border with an adjacent cell along a common boundary. In yet another aspect the step of imprinting further comprises imprinting access indicia selected from the group consisting of bar codes, quick response (QR) codes, uniform resource locators (URLs), email addresses, textual addresses, bibliographic statements, and footnotes, wherein the access indicia provides links to remote resources for further information about the subject matter depicted on the visual aid. In another aspect, the remote resources may include information presented in formats selected from the group consisting of animated graphic sequences, video sequences, articles, reports, documents, and data compilations.

### BRIEF DESCRIPTION OF THE DRAWINGS

FIG. 1 illustrates a first side of one embodiment of a visual aid component of the teaching system according to the invention;

FIG. 2 illustrates a second side of the embodiment of FIG. 1;

FIG. 3 illustrates a plan view of the front side of one embodiment of a modeling implement component of the teaching system according to the invention;

FIG. 4 illustrates a perspective view of the back side of the embodiment of the modeling implement of FIG. 3;

FIG. 5 illustrates one example of the use of the modeling implement—to depict the land masses of Pangea overlaid with distribution patterns of animals and plants during the Triassic era;

FIG. 6 illustrates another example of the use of the modeling implement—to depict the land masses of Pangea overlaid with the area representing the glaciers during the Triassic era; and

FIG. 7 illustrates another example of the use of the modeling implement—to depict the land masses of Pangea overlaid with mountain ranges existing during the Triassic era and appearing afterwards.

### DETAILED DESCRIPTION OF THE INVENTION

It is well known that visual aids can be very efficient instruments of learning new material, especially when the subject matter is new to the student. In teaching science to students, for example, particularly in middle school programs (elementary grades 6 through 8 or 9, although the teaching aids described herein are not limited to these ages), visual aids or project materials can be very effective, especially if they are efficient and constructing them does not consume much of the time allotted to classroom work in simple, manual, time-consuming activity. Many categories of educational subject matter lend themselves to relatively simple images or drawings of elements or segments of an assembly, pictorial elements or components of an object, maps of geographic regions, models of structural features, etc., to enhance descriptions and understanding of scientific concepts and theories. The teaching system described herein may be adapted to elementary or secondary, public or private or home schools, museums, camps, or other settings.

In the field of science, some examples of the use of the teaching system of the present invention include a model of continental drift, a model of an atom, a model of a cell or a chemical compound or a group of compounds, etc. In each of these examples a composite figure made up of segments representing an essential component of the assembly can be used to advantage in teaching the relationship of the segments to the whole, or of a process involving the segments and the whole, etc. The use of composite figures employing segments that fit together or share common boundaries, for example, can be extremely helpful in understanding a topic in a visual medium. This can be true whether the topic or subject is a geographic composite, or some apparatus composed of several related, principal components, or a chart or graph—i.e., an abstraction of the information represented—having different areas that can be represented as segments.

Another well-known technique for efficient learning is the use of hands-on (tactile or kinesthetic) learning experiences such as models, experiments, and projects that may employ some form of implement or device or other materials that can be held and manipulated to familiarize the student with the subject matter in an intimate and personal way that reinforces the textual or visual information presented to the student.

A further technique for enhancing the learning experience is the use of supplementary resource materials to expand upon the textual, visual, or experiential subject matter presented in organized instructor-student settings. These supplementary resource materials may include library readings, films, field trips or excursions, guest instructors, and the like. A relatively new medium with vast capabilities for supplying supplementary resource materials is through access indicia that provide computer access to the many databases available via universal or specialized networks such as the Internet.

The teaching system to be described may be adapted to many kinds of subject matter and to many variations of the basic two or three components described in the exemplary embodiment. In one embodiment of the present invention, the educational subject matter includes a scientific theory. A visual aid system 10 depicts one or more categories of information selected from the group consisting of origins, descriptions, mechanisms, and evidence of the scientific theory; a modeling implement 100 such as a die cutting tool may be used to construct a model of the conceptual idea underlying the theory and to experiment with some of the evidence that supports the theory; and links such as QR codes 20 to remote resource locations on a network may be used to access additional information about the theory and its implications.

The scientific theory of plate tectonics is one example of educational subject matter that can be made available at most grade levels in public or private schools, or in museums, camps, home schools, etc. In view of the disadvantages of traditional methods noted herein above, the inventors sought to develop an improved teaching system to convey the principles of this theory of geologic science in a simple and understandable way that maximizes the use of learning time, while involving the students in tactile and kinetic activity that contributes to the learning process in direct, interesting, and efficient ways. In this example a visual aid may be devised to depict one or more categories of information selected from the group consisting of origins, descriptions, mechanisms, and evidence of the scientific theory of plate tectonics. Each of these categories contains information about the who, what, how, and why of the scientific theory. For example, information about origins may include the names and biographies of discoverers of the theory or the history of insights, experiments, or other events that led to a rational statement of the theory. The description of a theory may include concepts, principles, maps, definitions, elements, or certain other aspects of the theory. Mechanisms of the theory may include processes or examples that participate or explain how the theory operates. Evidence that supports the theory may include the results of a body of experimental data from one or more experiments, research and exploratory expeditions and the like.

In one embodiment described herein, the invention includes three components, a visual aid device in the form of a sheet of material such as a work sheet or place mat (preferably laminated with clear plastic), a modeling implement such as a compound die cutting tool having a plurality of cells or cut outs, and access indicia providing links to remote resource material. In the illustrated example, the compound die cutting tool combines cutting edges shaped into cells representing each of the continental plates thought to have formed the supercontinent Pangea approximately 225 million years ago during the Triassic Age. The laminated place mat visual aid provides printed illustrations and textual information ready at hand while also providing an easily cleaned and reusable work surface for working with a modeling substance to produce models of each of the continental plates.

The models may be produced by using a modeling implement such as the compound die cutting tool. The tool may be used like a cookie cutter, pressed against a rolled-out layer of a plastic or moldable material such as modeling clay, Play Dough®, or other material—even edible cookie dough. The die cutting tool thus enables a set of cut out continental plates to be quickly made from the rolled-out modeling substance. The die cutting tool may be fabricated as a one piece panel formed of a molded thermoplastic material having legends identifying each cut out or cell formed in the top side of the panel and die cutting edges formed integral with the panel on the underside of the panel.

In another aspect of this combination—a third component—one or more access indicia or graphical links such as QR codes to web-based resources may be imprinted on the laminated place mat or even in the die-cutting tool. Examples of access indicia may include bar codes, quick response (QR) codes, uniform resource locators (URLs), email addresses, textual addresses, bibliographic statements, and footnotes. Such links may be used to connect the user—whether teacher or student—to additional information about the theory and its implications or about specific topics noted in a textual or graphical element of the visual aid.

The use of the illustrated embodiment of the teaching system may thus include the steps of (1) reading the first side of the work sheet or place mat to learn basic information; (2) use the second side of the work sheet or place mat to obtain additional information; (3) build a model using the modeling implement (and using the placemat as a work surface); and (4) use the QR codes or other links to remote sites to access more information about the subject matter. As will be described, the material available at these remote links may be in the form of animated sequences of visual or graphic information, videos, articles, reports, documents, data compilations, and the like. Selecting the QR code or other access indicia may link the student to a directory of resources for playback or download.

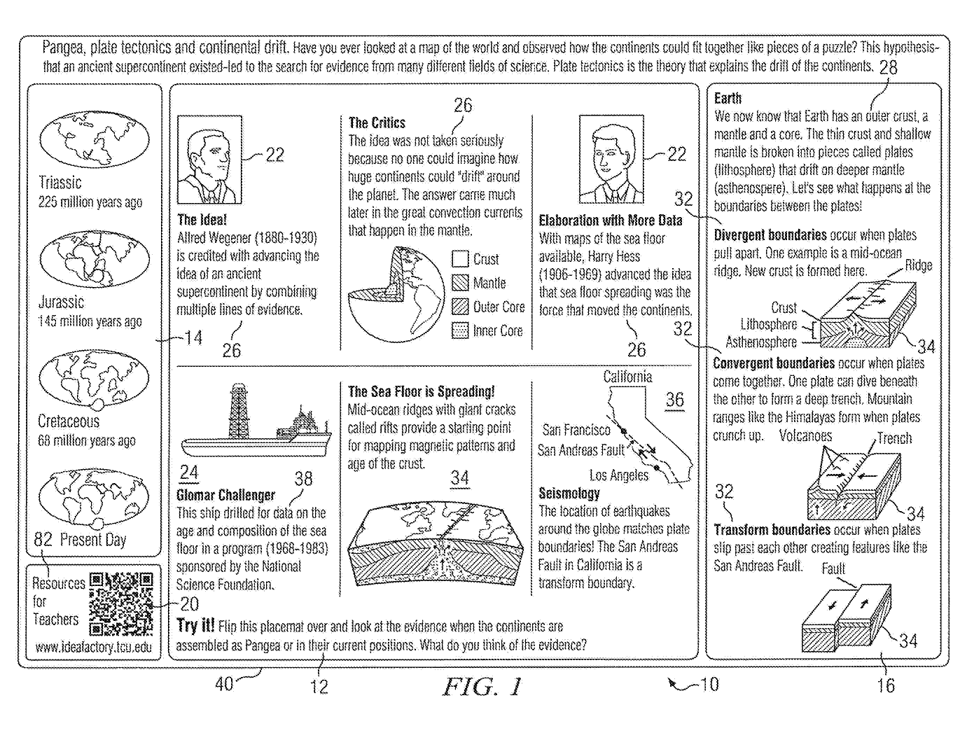

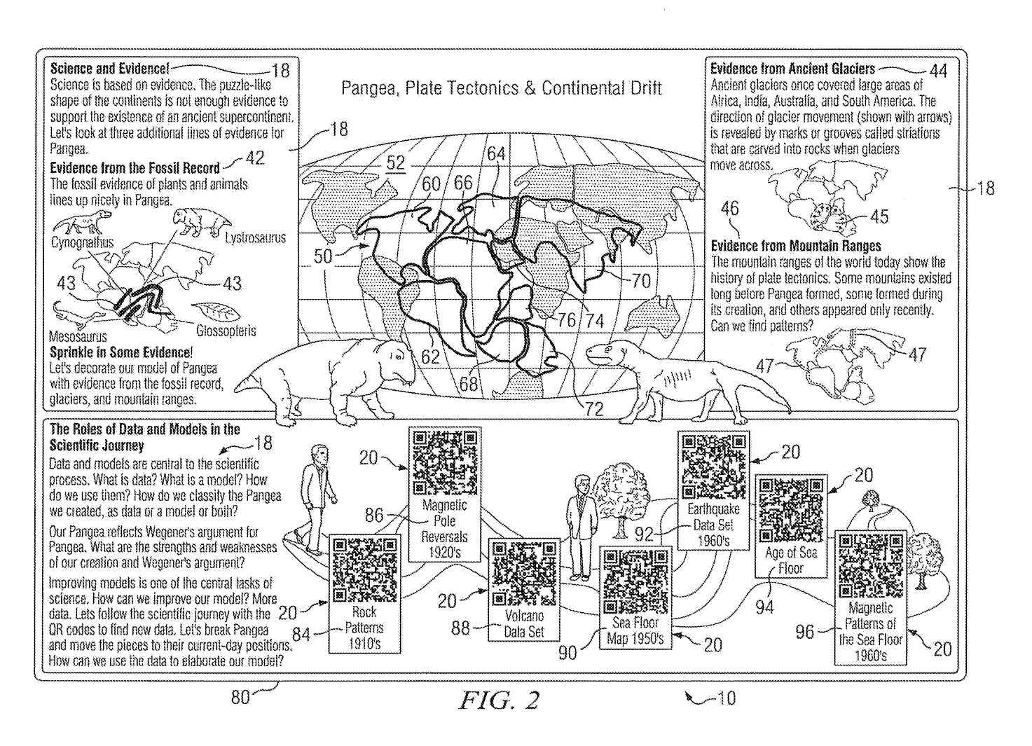

FIGS. 1 and 2 illustrate first 40 and second 80 sides of one embodiment of a visual aid 10 according to one aspect of the invention. When printed in a full color graphical image the visual aid 10, on its first side 40 shown in FIG. 1, introductory panel 12 may include brief information about the origins of and descriptions of some key features of the theory being presented. Other supplementary panels 14 may present further information about concepts 28, principles 30, and definitions 32 of the theory of plate tectonics and continental drift. This information presented in the panels 12 and 14 may include brief statements or graphics about the discoverers 22, important events 24, or insights 26 leading to the discovery of the theory. In this example two of the scientists 22 who originated the underlying ideas or insights 26 of a supercontinent and sea floor spreading are identified. Alfred Wegener is credited with advancing the idea of an ancient supercontinent by combining multiple lines of evidence. And Harry Hess is cited for advancing the other ideas including sea floor spreading as the mechanism that moved the continents.

Other information in the panels 12 and 16 on the visual aid 10 may include illustrated summaries of the mechanisms of sea floor spreading 34 and changes in the Earth's magnetic field 38 or the effects of plate migration on earthquakes 36, particularly along their borders, for example. Additional material that can be included is an explanation in one of the panels 14 of the three kinds of boundaries (see reference number 32) that are affected by movements 34 in the Earth's crust: divergent, convergent, and transform, which characterize the kind of motion that occurs between the continental plates. Similarly, a brief timeline of the geologic periods from the Triassic period to the present day may be shown as illustrated in another supplementary panel 14.

On the second side 80 of the visual aid 10 shown in FIG. 2 may be presented summaries of evidence from the fossil record 42, from ancient glaciers 44, and from mountain ranges 46. The graphic of the fossil record 42 includes regions 43 overlaying the boundaries of adjacent continental plates to show ranges and distribution patterns of plants and animals of the Triassic Age before the continental plates began to drift apart. Similarly, ancient glaciers 45 covered several adjacent plates until separated by the drifting of the plates, and mountain ranges 47 along common boundaries of several of the continental plates of Pangea 50 remained with their respective plates as they drifted apart.

Illustrated in the central portion of the second side 80 of the visual aid 10 in FIG. 2 is an outline map 50 of the continental land masses or “plates” as they are thought to have existed during the Triassic Age approximately 225 million years ago, forming the ancient Supercontinent of Pangea. The outline map 50 may be superimposed over a geographic outline map 52, presented in the same scale as an equal area projection, of the arrangement of the continental land masses as they presently exist. The outline map 50 of Pangea, hereinafter also called Pangea 50, includes seven continental plates and two other subcontinental plates as follows. The continental plates include North America 60, South America 62, Europe 64, Africa 66, Antarctica 68, Asia 70, and Australia 72. Subcontinental plates include the Arabian 74 and Indian 76 plates. In the illustrated example, the size of the place mat visual aid 10 is approximately 11×17 inches and the modeling implement 100 to be described is about 5½×8 inches. In this example, the scale of the island nations of Greenland and Madagascar are too small to include with clarity in the modeling implement 100 (die cutting tool). Greenland and Madagascar could be included in a die cutting tool that is defined and fabricated to finer precision.

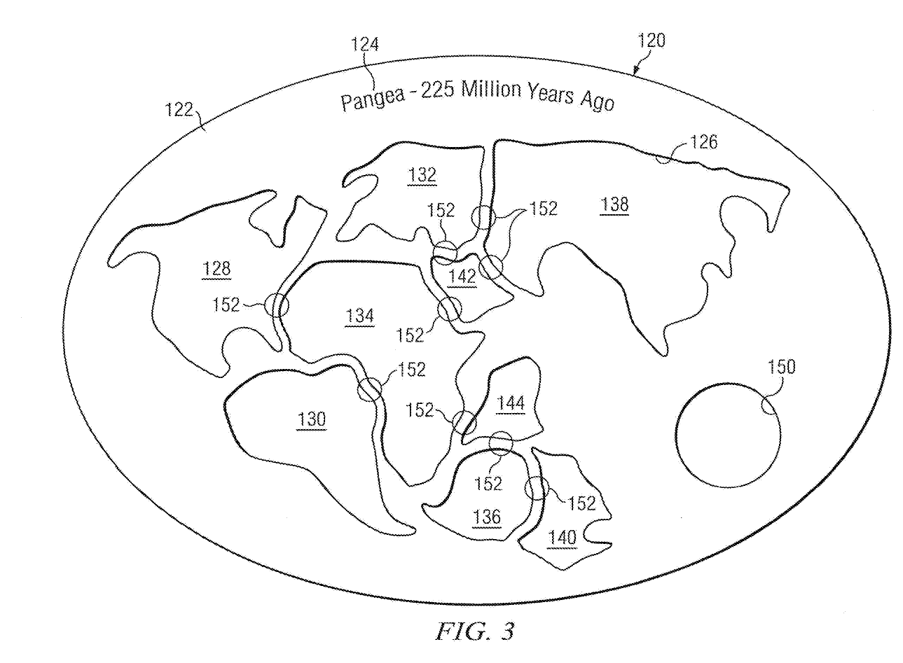

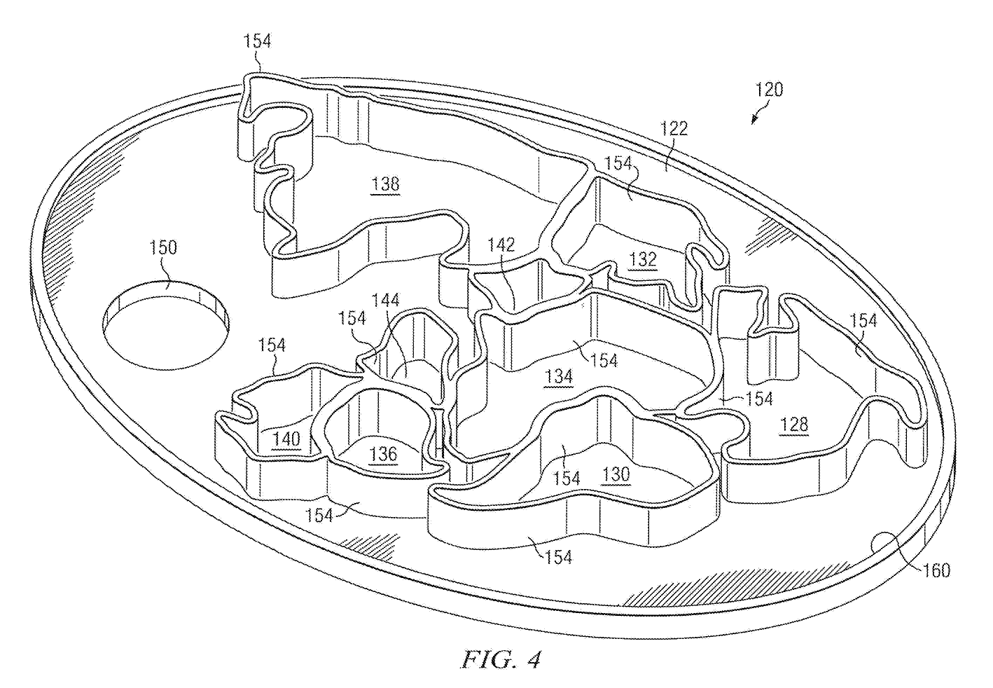

Continuing with FIGS. 1 and 2, a third component of the invention includes access indicia such as several quick response (QR) codes 20 that are provided to enable access to remote resource sites by connection over a network simply by scanning the QR code 20 of interest. For example, on the first side 40 in FIG. 1, a QR code providing access to resources for teachers 82 and a web address for teachers to connect to www.ideafactory.tcu.edu for additional information about the teaching aid system described herein. In FIG. 2 are shown QR codes as examples of the access indicia for students to obtain additional data and information about the subject matter of the teaching system that utilizes the visual aid 10 and the modeling implement 100 shown in FIGS. 3 and 4 as a die cutting tool 120. Examples shown on the second side 80 of the visual aid 10 include QR code links to topics such as rock patterns 84, magnetic pole reversals 86, volcano data set 88, sea floor map 90, earthquake data set 92, age of sea floor 94, and magnetic patterns of the sea floor 96. Each of these links may connect the student or user to animated sequences, videos, documents, articles, presentations, or reports containing information about the selected topic.

Further, the scale of the ancient map and the present day version are matched to the size and shape of the cells (to be described) that may be reproduced using the compound die cutting tool 120 (See FIGS. 3 and 4) in the embodiment described herein. Thus, cut outs made in modeling clay, Play Dough®, or cookie dough using the die cutting tool 120 may be assembled on the Pangea outline map 50 printed on the second side 80 of the visual aid 10 “place mat,” using the Pangea outline map 50 as a guide to placement of the continental plates. In other portions of the second side 80 of the visual aid 10, brief textual passages, with or without graphic images, may describe essential features of plate tectonics such as evidence 18 in support of the theory. A sidebar panel of review questions (not shown) about the material may be included as a study guide in an alternate embodiment. Instructions to students in the uses of the teaching system may also be included on either side of the visual aid 10.

FIGS. 3 and 4 respectively illustrate a front side view and a rear perspective view of one embodiment of a modeling implement 100 intended to be used with the visual aid 10 described herein above. The modeling implement 100 configured as a compound die cutting tool 120 in this embodiment may be a molded plastic panel 122 having cut out shapes representing each of the continental land masses of the Pangea supercontinent illustrated by the Pangea outline map 50 in FIG. 2. The die cutting tool 120 should be formed a food-safe material if it is intended to be used with cookie dough or other edible material to form the continental plate cut outs. Note that it is not intended that the die cutting tool 120 be baked along with the cookie dough because baking the cookies formed by the die cutting tool 120 requires oven temperatures that exceed the temperature range of thermoplastic materials suitable for the die cutting tool 120.

In the die cutting tool 120 the cut out shapes or cells are arranged as a single tessellated array of cells that appear to fit together because of the complementary configuration of their borders in accordance with the theory of plate tectonics. Raised edges 152 along the outlines may be provided to high-light the borders of the individual outlines or cells representing the continental plates. Legends imprinted into the surface may be used to identify each cell. When the die cutting tool 120 is used to make cut outs of the continental plates from modeling clay or dough, the plates, when assembled together correctly may be aligned with the outline map of the second side 80 of the visual aid 10 of FIG. 2, thereby forming a model of the supercontinent Pangea 50. This model can be studied as an assembled unit or the individual cells moved to simulate the movement of the individual continents through geologic time.

The embodiment depicted in FIGS. 3 and 4 may be called a compound die cutting tool 120 because of its principle function—to enable cutting in a single operation a plurality of outline figures that can be studied individually or as assembled together. FIG. 3 illustrates a front view of the die cutting tool 120. FIG. 4 illustrates a perspective view of the back side of the die cutting tool 120 from an oblique angle to depict the structure of the die cutting edges 154 to be described. The die cutting tool 120 may be made of a variety of materials, and fabricated as a homogenous unit or assembled from several materials. In the illustrated embodiment the die cutting tool 120 is formed as a single component molded from, e.g., a thermoplastic material, in the form of a panel 122. The panel 122 is provided with an opening or cut out formed in the panel 122 having the outline shape of each of the plates representing the land masses of Earth's surface. The nine plates include the seven continents and the Arabian and Indian Plates. The openings are arranged in the configuration of the land masses as they existed approximately 225 million years ago forming the Supercontinent of Pangea 50 as identified by the molded legend 124. The openings thus represent the continents of North America 128, South America 130, Europe 132, Africa 134, Antarctica 136, Asia 138, and Australia 140, and the subcontinent Arabian 142 and Indian 144 plates.

The borders of the cells representing the continental plates 128-144 may be each indicated by a slight raised ridge along the front surface of the panel 122, and shared in common in those places where the borders of the defined continental plates 128-144 coincide, as shown by the several positions of the reference number 152. Note that each of the borders of all the cells are represented by the reference number 152, though every such border is not so marked to avoid unnecessary clutter in the figure. Extending below each of the borders, preferably for a distance of ¼ to ¾ inch, on the underside of the one-piece molded panel 122 is a cutting edge or extension 154 formed similar to a steel rule die. Preferably the cross section of the cutting, or lower-most, edges of the extension 154 is thinner than the cross section at the base thereof adjacent the underside surface of the panel 120. That is, the cutting edges 154 resemble a knife blade in cross section. For cutting soft materials such as modeling clay or dough, a plastic cutting edge is sufficient. For materials such as paper, a metal knife blade profile such as a steel rule die to be described is preferred. An optional feature of the molded die cutting tool 120 is a thumb hole 150 that may be used when gasping the die cutting tool 120 or when storing it on a peg, for example, when not in use. The die cutting tool 120 may further include a circumferential rim 160 along the underside of the perimeter of the panel 122 to reinforce the panel 122 as shown in FIG. 4.

An alternate of the embodiment described in FIGS. 3 and 4 may have the cutting edge 154 portion replaced by a steel rule die. A steel rule die, as is well known, is often used to form die-cut figures from thin sheets of material such as heavy paper or cardboard, or thin sheets of other materials such as paper, plastic, leather, certain fabrics, etc. Such a steel rule die replicating the set of borders 152 of the cells that each represent the continents 128-144 of the ancient Pangea may be formed as a single unit by mounting the steel rule cutting blades forming the borders 152 of the cells on the underside of a panel 122 of wood, thermoplastic or other rigid material for maintaining stability of its shape in cutting, imprinting, or stamping operations. The cutting edges may be blunt or rounded for cutting through modeling clay or dough materials, or may be sharp for cleanly cutting through various more rigid materials. In other alternate embodiments, the die cutting tool may be a set of individual continental plate cutters that can be used singly or assembled together. In another alternate embodiment, the modeling implement may be configured as a muffin pan or a candy mold (not shown, as it is a well-known device) with receptacles for the dough instead of cut out areas. The modeling implement may in general be configured for cutting, deforming, stamping, or printing a deformable or non-deformable material.

In another alternate embodiment the modeling implement 100 may be replaced by a set of ready-made cutouts of the continental plates, made of a durable material, to eliminate the need to supply the clay or dough material and the time needed to use the modeling implement to form the cut outs. The plate cut outs may then be assembled and/or moved about according to a lesson plan, for example, and reused as desired.

The visual aid and modeling implement or die cutting tool of FIGS. 1, 2, 3, and 4 may further include printed thereon instructions to students and teachers in the uses of the teaching aid 10.

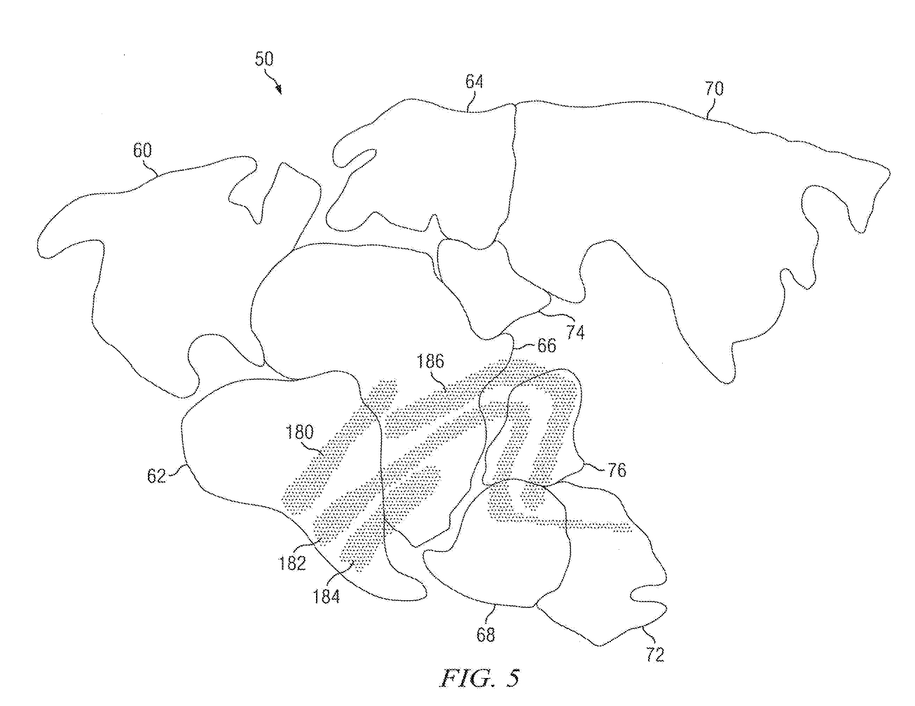

The teaching system of the present invention offers a variety of possible uses. For example, after using the die cutting tool 120 to make cut-outs of the landmasses of Pangea 50, either from modeling clay or dough, a student may position the cut outs over a map of Pangea 50 as shown in FIGS. 5, 6, and 7 to be described. The cut outs may be placed on a map of Pangea or superimposed over a map, in a similar scale and projection, of present day Earth 52. The individual continental plates may be moved in the directions predicted by plate tectonics theory to simulate the drift of the plates through time. Alternatively, if time permits or as a homework assignment, a student may construct “decorations” of the Pangea 50 continental plates—just as if he or she were decorating a cookie or a cake with various kinds of materials—by overlaying the surface of the molding clay or dough, or other cut outs with a “frosting” or separate cut out applied to specific areas of the continental plates. In this way, the student can locate the distribution patterns 43 of individual animals or plants, or the glaciers 45, or the mountain ranges 47 (see FIG. 2) of Pangea 50. Different decorations may be devised for different time periods, or a sequence of continental positions and geologic phenomena may be illustrated and tracked with different models that use the same basic structure of the Pangea model described herein. In both examples described herein the student may enhance their study of the subject matter by selecting one or more of the QR codes on the place mat 12 to access additional resource material. These are just two examples of how the pictorial teaching aid system of the present invention may be used in classroom exercises and experiments to demonstrate the principles of plate tectonics. FIGS. 5, 6, and 7 that follow illustrate the appearance of the supercontinent Pangea 50 during the Triassic era when the evidentiary features of Pangea 50 discussed above are superimposed over the land masses of Pangea.

FIG. 5 illustrates the land masses of Pangea 50 overlaid with distribution patterns of animals and plants during the Triassic era. These patterns, derived from the fossil record and identified with reference number 43 in FIG. 2, include ranges and distribution patterns 180, 182, 184, and 186 that crossed the adjoining boundaries of the continental plates.

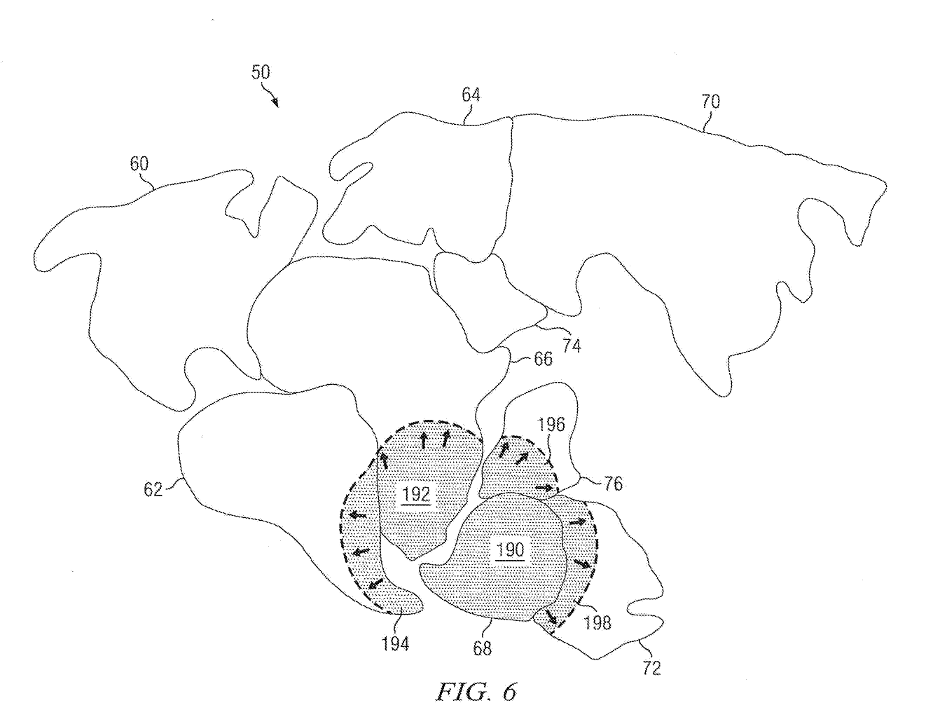

FIG. 6 illustrates the land masses of Pangea 50 overlaid with the areas representing the glaciers during the Triassic era. These areas, identified with reference number 45 in FIG. 2, include the glacial areas 190 over Antarctica, 192 over Southern Africa, 194 over the eastern portion of southern South America, 196 over the southern half of the Indian subcontinent, and 198 over the portion of the Australian continent adjacent Antarctica. The small arrows near the dashed line outer boundaries of the glacier regions may be used to indicate the direction of movement of the glacier boundaries during the Triassic era based on evidence of striations carved in rocks as the glaciers moved across them.

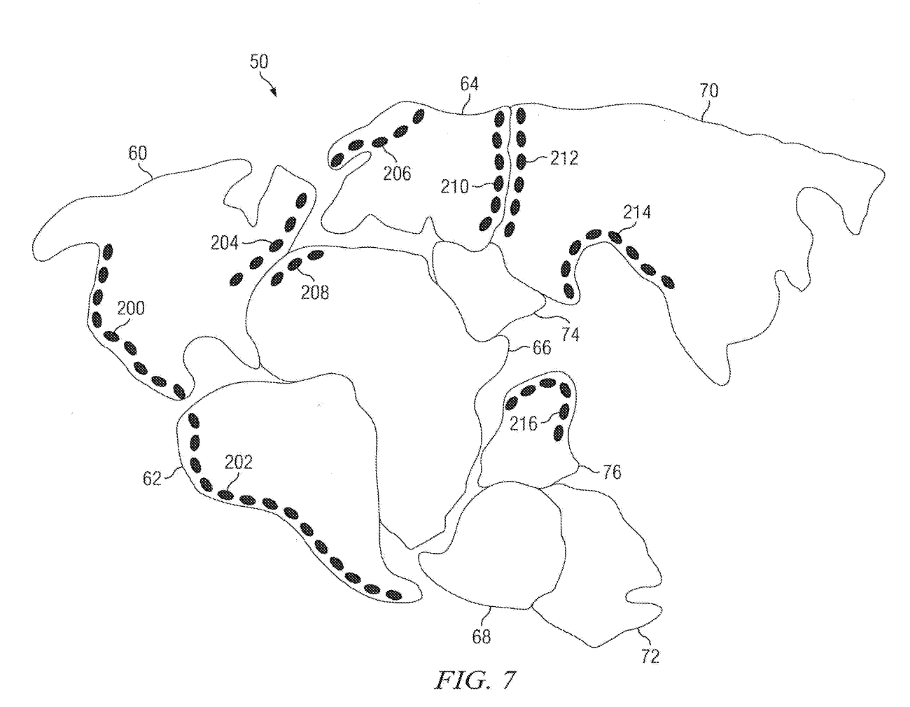

FIG. 7 illustrates the land masses during and after Pangea 50 overlaid with mountain ranges that existed during the Triassic era prior to the beginning of continental drift. These ranges, identified with reference number 47 in FIG. 2, include Mountain ranges 200 and 202, which represent the Coastal, Cascade, and Rocky Mountain ranges along the western coast of North and the Andes Mountain ranges of South America. Similarly, Ranges 204 and 206 represent the Appalachian Mountains along the eastern coast of North America and the mountain ranges along the western coast of Scandinavia, range 208 forms the Atlas Mountain range along the northwest coast of Africa. 210 and 212 correspond to the Ural Mountains of eastern Europe and western Asia. The Himalaya Mountain range 214 is shown along the southern border of Asia and the northern border of the Indian subcontinent.

FIGS. 5, 6, and 7 provide a few examples of ways the cut outs formed using the modeling implement or die cutting tool 120 may be used to study some of the evidence for plate tectonics. The model thus constructed provides clear visual depiction of Pangea 50 and some important features of the evidence found by scientists that supports the theory of plate tectonics. Each of the features represented by the added overlays and present before the drift of the continents began remained with the continental plate they were originally part of as the plates moved away from or toward each other. As the plates drifted apart these features were carried along, helping students to understand the origins of the geographic features as we know them in the present era.

The technique illustrated in FIGS. 5, 6, and 7 may be applied to other geographic features of the continents, during different geologic periods, to demonstrate the dynamism of the Earth's crust and how changes in climate and the environment are related to the geology of the planet. As an atlas depicts the facts of geology, the pictorial teaching system described herein may be used to provide hands-on learning experiences for students to enhance their understanding that geology is not a static science but one that is characterized by continuing change. This same characteristic is true of many subjects in science in the broadest sense. Thus, the teaching system of the present invention, comprising the three basic components—the visual aid, the modeling implement, and the access indicia—may be applied to a wide variety of subject matter as illustrated by the example described herein, but limited only by the ingenuity of the instructor in applying the method to their teaching circumstance.

While the invention has been shown in only several of its forms, it is not thus limited but is susceptible to various changes and modifications without departing from the spirit thereof. For example, a separate die cutting tool may be fabricated for each cell or continental plate. When such separate cells are made to the same scale, the cut out pieces may be assembled into a combined model of the supercontinental land mass called Pangea, as described herein, or assembled in smaller groups for study of cell-to-cell relationships, etc. The die cutting tool described herein is not limited to the major continental plates illustrated but may include smaller land masses such as islands or other features. The tool may be used for cutting or impressing any suitable deformable or divisible material or printing an image of the supercontinent and/or its components using ink on a substrate such as paper or other sheet materials. Other materials such as booklets may be provided to supplement the subject matter in printed form.

As mentioned herein above, the concepts of the invention may be extended to other subject matter, particularly those that are readily depicted in pictorial fashion. Though particularly well-adapted to the geographic or geologic fields, the teaching system disclosed herein may find ready application in many other fields where maps or outline drawings are employed to represent land mass areas or other components of composite structures that can be represented pictorially. Further, as this is written, the teaching system of the present invention is being used in 80 Independent School Districts in the State of Texas and 15 other sites (schools and museums), and by some 200 teachers. This rapid adoption of the invention has taken place within the first ten months of its availability.

What is claimed is:

1. A teaching system, comprising:
a visual aid printed on first and second sides of a sheet material describing educational subject matter;
a die cutting tool having a plurality of separate die cutting cells formed in a panel, each said cell representing one of an assembly of related components of said educational subject matter, for modeling a concept of said subject matter described on said visual aid; and
at least one resource access indicia imprinted on said visual aid.

2. The teaching system of claim 1, wherein:
said visual aid is formed as a place mat comprising said sheet material printed on said first and second sides and laminated between first and second clear sheets.

3. The teaching system of claim 1, said visual aid further comprising:
a place mat having information on said first side about origins and descriptions of a scientific theory; and
a second side of said place mat having information about mechanisms and evidence of said scientific theory.

4. The teaching system of claim 1, said visual aid further comprising:
a place mat having at least one illustrated side containing information about a scientific theory selected from the group of information consisting of origins, descriptions, mechanisms, and evidence of said scientific theory.

5. The teaching system of claim 1, said die cutting tool further comprising:
a tessellated array of cells, wherein each cell is formed as an opening in said panel representing a defined element of said assembly and each cell shares a portion of its border with an adjacent cell along a common boundary; and
each cell boundary includes a die cutting edge formed there along and extending from one side of said panel.

6. The teaching system of claim 1, said visual aid further comprising:
a place mat having information on said first side about origins and descriptions of plate tectonics and continental drift; and
a second side of said place mat having information about mechanisms and evidence of said plate tectonics and continental drift.

7. The teaching system of claim 6, wherein said die cutting tool comprises:
a tessellated array of cells, wherein each cell represents a tectonic plate of Earth's crust and each cell shares a portion of its border with an adjacent cell along a common boundary; and
each cell boundary is formed by a die cutting edge formed there along and extending from one side of said panel.

8. The teaching system of claim 5, wherein further:
said die cutting edges of said tessellated array of cells are supported in a planar frame to provide stability of said die cutting tool.

9. The teaching system of claim 5, further comprising:
a one piece molded thermoplastic panel having legends identifying each said cell formed in a top side of said panel; and
die cutting edges formed in an underside of said panel.

10. The teaching system of claim 5, said die cutting edge further comprising:
a steel rule die secured to said planar frame.

11. The teaching system of claim 1, said resource access indicia comprising:
access indicia selected from the group consisting of bar codes, quick response (QR) codes, uniform resource locators (URLs), email addresses, textual addresses, bibliographic statements, and footnotes.

12. The teaching system of claim 1, said resource access indicia comprising:
QR code links to remote resources for further information.

13. The teaching system of claim 1, said resource access indicia comprising:
QR codes printed on said visual aid providing links to remote resources for further information about the subject matter depicted on said visual aid.

14. The teaching system of claim 13, said remote resources comprising:
information presented in formats selected from the group consisting of animated graphic sequences, video sequences, articles, reports, documents, and data compilations.

15. The teaching system of claim 1, said visual aid further comprising:
a place mat having said first side illustrating origin and description of a scientific theory; and
a second side of said place mat illustrating mechanisms and evidence of said scientific theory.

16. The teaching system of claim 1, wherein:
said educational subject matter includes a scientific theory and said visual aid depicts one or more categories of information selected from the group consisting of origins, descriptions, mechanisms, and evidence of said scientific theory.

17. A teaching system, comprising:
a visual aid formed as a place mat having at least one illustrated side containing information about a scientific theory selected from the group of information consisting of origins, descriptions, mechanisms, and evidence of said scientific theory;
a die cutting tool having a tessellated array of die cutting cells formed in a panel, each said cell representing one of an assembly of related components of said scientific theory and each cell boundary including a die cutting edge formed there along and extending from one side of said panel, for modeling in a moldable material a concept of said scientific theory described on said visual aid; and
at least one resource access indicia imprinted on said visual aid or said die cutting tool providing links to remote resources for further information about said scientific theory.

18. The teaching system of claim 17, wherein:
said place mat is printed on first and second sides and laminated between first and second clear sheets;
said first side includes information about origins and descriptions of said scientific theory; and
said second side includes information about mechanisms and evidence of said scientific theory.

19. The teaching system of claim 17, wherein said die cutting tool further comprises:
a one piece panel formed of molded thermoplastic material having legends identifying each cell formed in a top side thereof and die cutting edges formed integral with said panel on an underside thereof.

20. The teaching system of claim 17, said resource access indicia comprising:
access indicia selected from the group consisting of bar codes, quick response (QR) codes, uniform resource locators (URLs), email addresses, textual addresses, bibliographic statements, and footnotes.

21. A method for teaching a scientific theory, comprising the steps of:
providing a printed sheet having at least one illustrated side containing information about a scientific theory selected from the group of information consisting of origins, descriptions, mechanisms, and evidence of said scientific theory.
providing a modeling implement for modeling at least one principal concept of said scientific theory; and
imprinting said printed sheet or said implement with at least one resource access indicia to connect a student or teacher to remote resource materials about said scientific theory.

22. The method of claim 21, further comprising the steps of:
configuring said printed sheet as a place mat, said implement as a die cutting tool, and said resource indicia as a quick response code.

23. The method of claim 22, wherein the step of providing a modeling implement for modeling comprises the steps of:
providing a die cutting tool with a tessellated array of openings formed in a panel; wherein
each said opening defines a cell in said panel, each said cell defining an element of an assembly of such cells; and
wherein each cell shares a portion of its border with an adjacent cell along a common boundary.

24. The method of claim 21, wherein the step of imprinting further comprises:
imprinting access indicia selected from the group consisting of bar codes, quick response (QR) codes, uniform resource locators (URLs), email addresses, textual addresses, bibliographic statements, and footnotes.

25. The method of claim 21, wherein the step of imprinting comprises the steps of:
imprinting resource access indicia providing links to remote resources for further information about the subject matter depicted on said visual aid.

26. The method of claim 25, said remote resources comprising:
information presented in formats selected from the group of information consisting of animated graphic sequences, video sequences, articles, reports, documents, and data compilations.
